(19) United States
(12) Patent Application Publication
(10) Pub. No.: US 2004/0166246 A1
(43) Pub. Date: Aug. 26, 2004

(54) Process and composition for treating wood

(76) Inventor: Robert R Holcomb, Nashville, TN (US)

Correspondence Address: COOLEY GODWARD, LLP, 3000 EL CAMINO REAL, 5 PALO ALTO SQUARE, PALO ALTO, CA, 94306, US

(21) Appl. No.: 10/473,873

(22) PCT Filed: Mar. 29, 2002
(86) PCT No.: PCT/US02/10128

(51) Int. Cl. B05D 1/18; C09D 5/16; C09D 5/18

(52) U.S. Cl. 427/440; 106/18.12; 428/537.1

(57) ABSTRACT

A process for reducing the rate of deterioration of wood that includes contacting the wood with an aqueous alkanline colloidal silicon-containing slat composition that is supersaturated with a boron-containing salt. The contacting may be at ambient or elevated temperature and pressure. The composition is an aqueous colloidal silicon-containing salt that is supersaturated with a boron-containing salt and optionally includes an aluminum salt and a preservative. The composition is made by mixing the boron-containing salt with a colloidal, aqueous mixture of a silicon-containing salt and optionally adding the aluminum salt and the preservative. The process is performed under conditions that result in a supersaturated solution of the boron-containing salt. Wood treated with the composition appears to be resistant to insects, rot, UV deterioration, fire, and other environmental insults. The wood also appears to have increased strength.

### CROSS-REFERENCE TO OTHER APPLICATION

This application claims priority to U.S. Provisional Application U.S. Ser. No. 60/______ filed Mar. 30, 2001, and is a continuation-in-part thereof. The provisional application is incorporated in its entirety by reference therein. The title of the provisional application is “Apparatus and Process for the Synthesis and Application and Uses of an Inorganic Polymer Based Wood Preservative.”

### FIELD OF THE INVENTION

This invention relates to a process for improved wood preservation by the synthesis and use of a non-toxic, environmentally friendly aqueous composition with increased effectiveness over current technology.

### BACKGROUND OF THE INVENTION

Wood preservation is the technique of reducing the rate of deterioration of wood by: 1) biological agencies of fungi, insects, marine bares, 2) damaging sun rays and 3) fire. Wood preservation is generally achieved by a chemical treatment. Wood preservation increases the useful life of wood and reduces the cost of frequent replacement. Properly designed wood structures give long service without special protection, but large economic loss may result when wood in its natural state is used at high temperatures, in structures exposed to salt water, or under climate conditions that favor the development of harmful fungi and insects.

The wood preservatives in general used today are oils, including oil borne and water borne chemicals. Oils are used widely for outdoor use. They do not smell in water but they contribute to staining and painting difficulties. Coal tar creosote alone, or in 5% pentachlorophenol in petroleum oil are used for treatment of products such as ties, posts, poles, pilings and construction timbers. Another common treatment solution is water based and contains copper, chromium and arsenic salts (CCA).

However, the wood preservatives that are in use today have several deficiencies. Both creosote and CCA present great hazards to the environment due to their significant toxicity to both plants, humans, and animals. Even with the liability of environmental toxicity these current wood preservations are totally ineffective against an astronomical problem here in the United States. A quote from TIME Magazine tells the story “Termites from Hell”. “Forget killer bees: Formoson termites are the real threat. They're chewing up the Southern U.S.—and no one knows how to stop them.” The Formoson termite is a subterranean termite native to East Asia. It was first introduced to the U.S. mainland just after World War II. It is believed to have been carried from Far Eastern ports in planks or packing crates by military cargo ships. The average domestic termite colony will eat 7 pounds of wood per year. A Formoson termite colony will eat 1,000 pounds per year. They cause collectively over $1 to $2 billion in damages, repair and control per year across the U.S. and some $350 million per year in the hardest hit city, New Orleans, La.

It is apparent that an effective, less environmentally toxic wood preservative which will repel the Formoson termite should be developed. The present invention fulfills the need with additional advantages that will be apparent upon further reading of this application.

### SUMMARY OF THE INVENTION

One aspect of this invention is a process for reducing the rate of deterioration of wood. The process comprises contacting wood with an aqueous mixture comprising an alkaline, colloidal composition, of a silicon-containing salt having boron ions incorporated therein for time sufficient to impregnate at least a portion of the wood with the mixture. The wood may be contacted by immersing the wood in the aqueous mixture at a pressure above atmospheric pressure in a closed container or may be sprayed or brushed on. Once dried the wood is very resistant to rot, insects, and other environmental insults.

Another aspect of this invention is an article of manufacture that comprises wood impregnated with a silicon-containing salt, a boron-containing salt, and optionally an aluminum halide. Generally, the silicon-containing salt is present at a level in the wood of about 1% w/w to about 30% w/w and the boron-containing salt is present at a level in the wood of about 1% w/w to about 30% w/w. If present, the aluminum salt will be present at a level less than about 1% w/w.

Still another aspect of this invention is a colloidal composition that comprises water, an alkali metal hydroxide in a quantity sufficient to bring the pH of the water to at least 10, a silicon-containing salt, a boron-containing salt, optionally aluminum halide, and optionally a preservative.

A further aspect of this invention is a process for making a composition suitable for reducing the rate of deterioration of wood. The process comprises mixing a boron-containing salt with an alkali-metal silicate solution at a pH of at least 10, optionally adding an aluminum halide and a preservative, and mixing to form a uniform colloidal composition being supersaturated with the boron-containing salt.

### BRIEF DESCRIPTION OF THE DRAWINGS

For further understanding of the nature, objects and advantages of the present invention, reference should be had to the following detailed descriptions, read in conjunction with the following drawings, wherein like reference numerals denote like elements and wherein:

FIG. 1 is a representation of the believed evolution of the polymer in an electret generator with a step gradient magnetic field with K⁺ ions or the nucleus and stabilized by the K⁺ ion with sequestration of the boron ion and water.

FIG. 2 is a representation of bound water on a typical colloidal particle made by standard activation techniques.

FIG. 3 is a schematic drawing of an electret generator useful for making the composition of the invention.

FIG. 4 is a schematic drawing of an electret generator of FIG. 3 demonstrating the three magnetic quadripolar booster generators and other modifications.

FIG. 5 is a representation of a detailed schematic drawing of the magnetic quadripolar generator with its flux fields and gradients.

FIG. 6 is a representation of the sequestration of boron ions by the silica colloid in the composition of the invention.

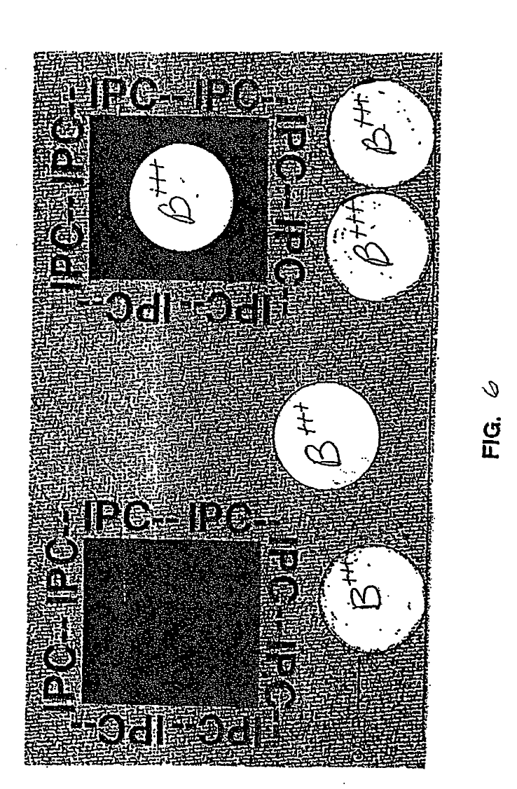

FIG. 7 is a representation of the pressure treatment apparatus of the invention for treating a variety of wood products.

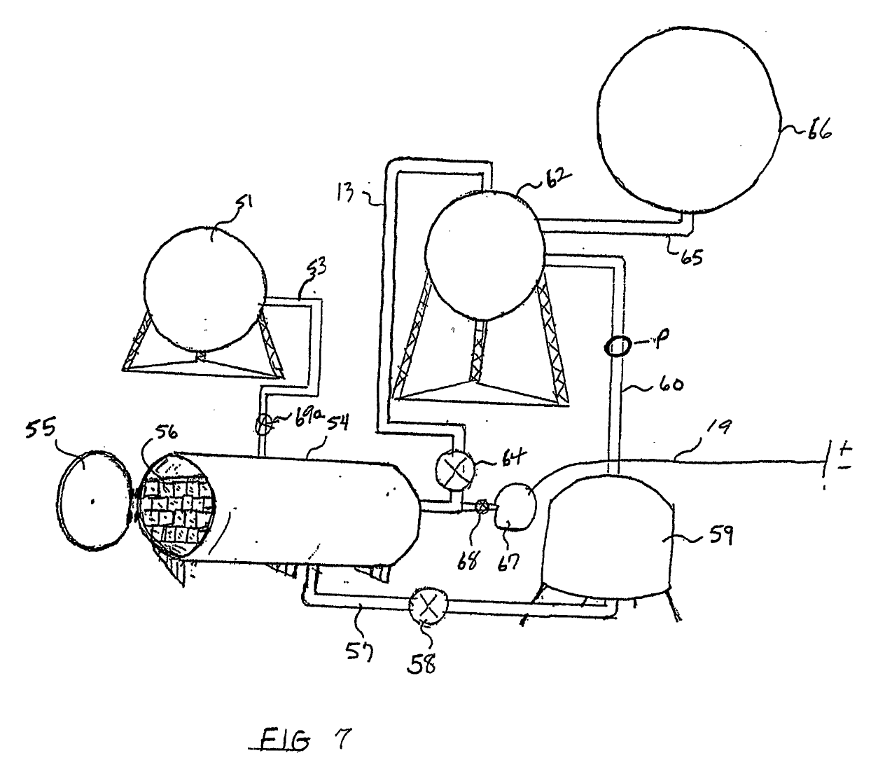

### DETAILED DESCRIPTION OF THE INVENTION

Wood, as used for structures such as houses, decks, fences, marine pilings, utility poles, railroad ties, and the like tends to deteriorate over time due to a multiplicity of environmental insults. One aspect of this invention is a process for reducing the rate of deterioration of wood. The process comprises contacting wood with an aqueous, alkaline, colloidal composition of a silicon-containing salt having boron ions incorporated therein for time sufficient to impregnate at least a portion of the wood with the mixture. Preferably the wood is contacted by immersing the wood in the aqueous mixture at a pressure of above atmospheric pressure for a period of time that is sufficient to ensure at least a portion of the silicon-containing salt and a boron-containing salt is deposited on or within the wood being treated. The process is carried out at a pressure of about 125 psi to about 175 psi, and the temperature may be ambient or elevated. The pressure is maintained for a time sufficient to impregnate most of the wood, e.g. about 30 minutes to about 2 hours. The wood may be cotreated with aqueous calcium silicate for improved results.

In the preferred, high pressure treatment, the pressure is maintained for a period of time dependant on the quantity, the porosity, and the length of wood being treated to impregnate the wood throughout its entire structure. After the wood has been impregnated with the composition, the wood is removed from contact with the aqueous composition and dried to provide a product having the silicon-containing salt and the boron-containing salt deposited therein. Drying may be done at ambient or elevated temperatures and pressures. If the wood is pressure treated and dried under ambient conditions, the drying may take 30 days or more. It appears that by pressure-treating wood in accordance with the invention, the silicon-containing salt and the boron-containing salt are deposited throughout the wood, resulting in a weight increase that may vary from 20% to 70% increase over the untreated wood. It is thought that the colloidal composition is drawn into the wood, perhaps by capillary action, and the salts are deposited throughout the fibrous structure of the wood. The weight increase will depend on the temperature, pressure, wood porosity, wood size, colloid composition and the like.

The process is carried out using an alkaline colloidal composition comprising water made basic to a pH of at least about 10 with an alkali metal hydroxide, a silicon-containing salt, a boron-containing salt, and optionally an aluminum halide. The details of the composition will be discussed hereinafter.

While the process of this invention is particularly applicable to immersion of wood within the aqueous composition, the wood may also be impregnated by contacting through application at ambient pressure and temperature of the aqueous composition to the surface of the wood and allowing it to dry. Such application may be done by application with a brush, pouring the composition onto the wood surface, spraying the composition on, and the like. Once the composition is applied, the wood is dried for a period of time to ensure the impregnation of the wood at the surface is complete.

Another aspect of this invention is an article of manufacture that comprises wood impregnated with a silicon-containing salt, a boron-containing salt, and optionally an aluminum halide. In the article of manufacture, the silicon-containing salt is present in the wood at a level of about 1% w/w to about 30% w/w and the boron-containing salt (e.g. metal borate or boric acid) is present at a level in the wood of about 1% w/w to about 30% w/w, with the aluminum halide present up to about 1% w/w. The dry weight of an article of this invention (made by pressure treatment) will be 20% to about 70% greater than comparable untreated wood. If the article is prepared by brushing or spraying, the impregnation is primarily surface, and the weight increase is less, i.e. no more than 10%. The ultimate increase will depend on a number of factors discussed hereinbefore.

Another aspect of this invention is a colloidal composition that comprises water, an alkali metal hydroxide in a quantity sufficient to bring the pH of the water to at least 10, a silicon-containing salt, a boron-containing salt, optionally an aluminum halide, and optionally a preservative. The silicon-containing salt will preferably be silica or sodium silicate, while the boron-containing salt will be borax or boric acid. The composition is the combination of an alkali metal hydroxide and a silicon-containing salt, preferably a colloid solution (or suspension), an alkali metal silicate such as sodium or potassium silicate, or silica dissolved in an aqueous solution of an alkali metal hydroxide. The composition will be an aqueous colloidal suspension. A useful description of the properties of colloidal silica can be found in “The Chemistry of Silica” by Ralph K. Iler, John Wiley & Sons, N.Y. (1979). Preferably the alkali metal hydroxide is sodium hydroxide or potassium hydroxide, particularly the latter. Mixtures of the two are also useful. Generally the silicon-containing salt is present at a level of about 2% w/v to about 20% w/v, at least about 4% w/v, and the boron-containing salt (e.g., borax) is present at a level of about 2% w/v to 20% w/v. The composition may include a preservative such as tripotassium citrate present in a stabilizing amount and an aluminum halide, e.g. aluminum trichloride or aluminum trifluoride, present in up to about 1.0% w/v. Generally, the colloid particles will exhibit a high zeta potential, i.e. about −40 to −75 mV.

The process for making the composition of this invention involves

(a) mixing a boron-containing salt with an alkali-metal colloidal composition of a silicon-containing salt having a pH of at least about 10,

(b) optionally adding an aluminum halide and a preservative, and

(c) mixing to form a uniform colloidal composition that is supersaturated with regard to the boron-containing salt.

The most plentiful silicon-containing salt occurs in nature as silica and is also known as silicon dioxide (SiO₂). It comprises nearly sixty percent of the earth's crust, either in the free form (e.g., sand) or combined with other oxides in the form of silicates. Silica is not known to have any significant toxic effects when ingested in small quantities (as SiO₂ or as a silicate) by humans and is regularly found in drinking water in most public water systems throughout the U.S. The preferred composition useful in this invention is an alkaline aqueous silica colloidal composition, which can be referred to as a solution or a colloidal suspension.

The aqueous composition is prepared by dissolving particulate silica in highly alkaline water which is prepared by dissolving a strong base in water to provide an aqueous solution that is basic (i.e., a pH of more than 7, preferably at least 10). In general the strong base will be sodium hydroxide or potassium hydroxide, preferably the latter. A molar quantity of at least 3 will generally be used to prepare the alkaline solution with no more than 4 molar generally being needed. Because the solubility (its ability to form a stable colloidal composition) of silica increases with increasing temperature, it is preferred that the alkaline solution be heated to a temperature above ambient, up to and including the boiling point of the solution. While temperatures above this may be employed, this is generally not preferred due to the need of a pressurized container. In dissolving silica in water made alkaline with sodium hydroxide, it is thought that a sodium silicate solution is formed. The composition will vary with respect to the varying ratios between sodium and silica, as will the density. The greater the ratio of Na₂O to SiO₂ the greater is the alkalinity and the tackier the solution. Alternatively, the same end can be achieved by dissolving solid sodium silicate in water. Numerous aqueous sodium silicate colloidal compositions are available commercially at about 20% to about 50% w/v. A well-known solution is known as “egg preserver” which may be prepared by this method and is calculated to contain about 40% by weight of Na₂ Si₃O₇ (a commonly available dry form of a sodium silicate). A standard commercially available sodium silicate is one that is 27% w/v sodium silicate.

While not wishing to be bound by any particular theory, it is believed that the chemistry of the dissolution may be approximated in the following equations.

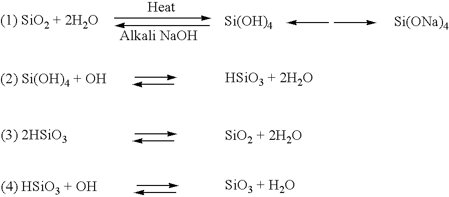

This is further discussed in Iler's book, supra.

Once the colloidal alkaline silica composition is prepared, a boron-containing salt, e.g. boric acid or a metal borate such as sodium borate, i.e. borax, is added to the mixture, preferably as a finely divided powder. It is thought that the addition of the boron-containing salt aids in forming a stable colloidal composition having the boron ions integrated into the colloidal structure. In addition, an aluminum halide and a preservative may also be added. The addition of the source of B⁺⁺⁺ ions, a preservative such as tripotassium citrate, and the aluminum halide may be lead to polymerization of the Si(OH)₄ as visualized below:

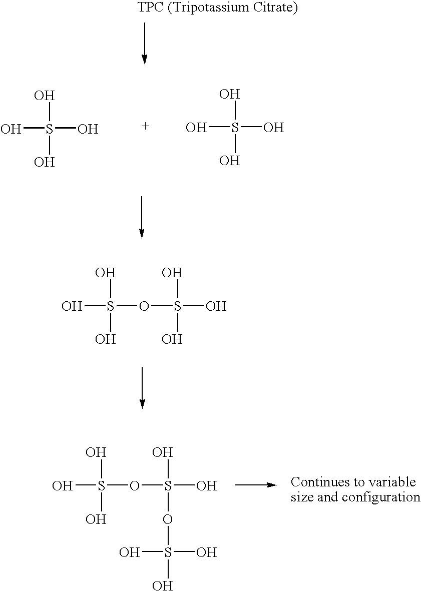

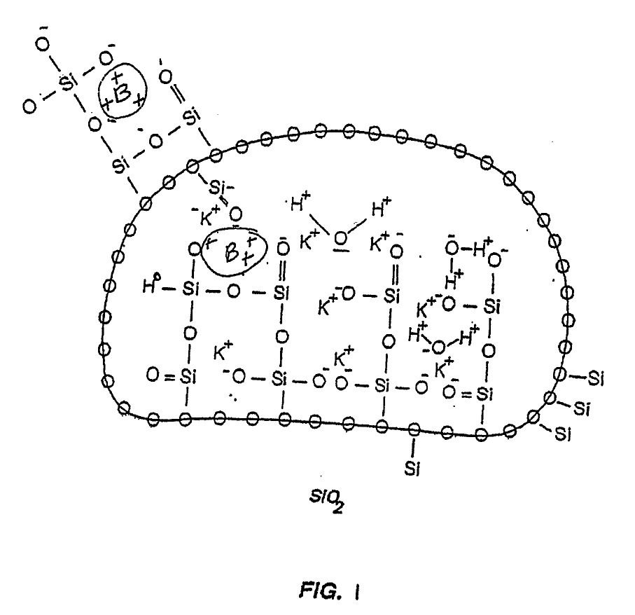

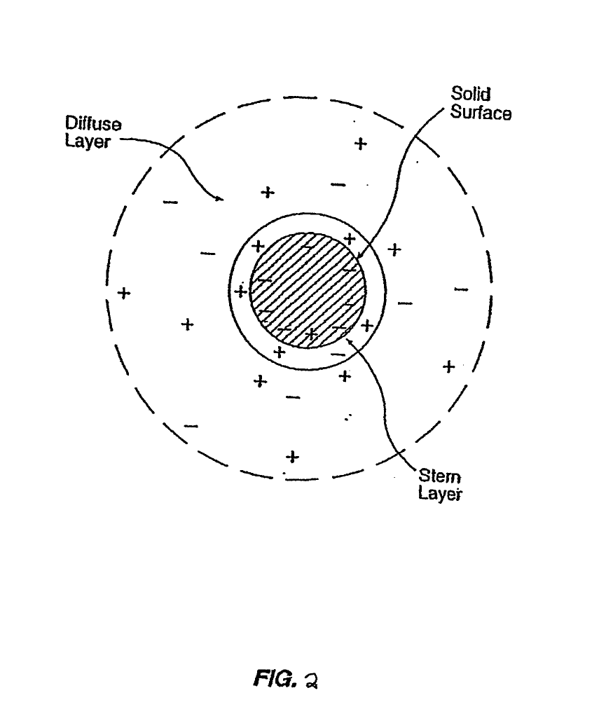

This is thought to lead to a colloid particle in which B⁺⁺⁺ ions are sequested as shown in FIG. 1. Note that in FIG. 1 the alkaline used could be potassium hydroxide, which provides the K+ ions, along with TPC. The colloid of this composition is thought to be more tightly bound and more extensively branched than known colloid systems. It is further thought that FIG. 2 is representative of the typical double layer of water found on a typical silica colloid particle.

In the process, the boron-containing salt is preferably borax, i.e. sodium borate, also known as sodium biborate and other names, with a formula of Na₂B₄O₇. It is often found as the decahydrate.

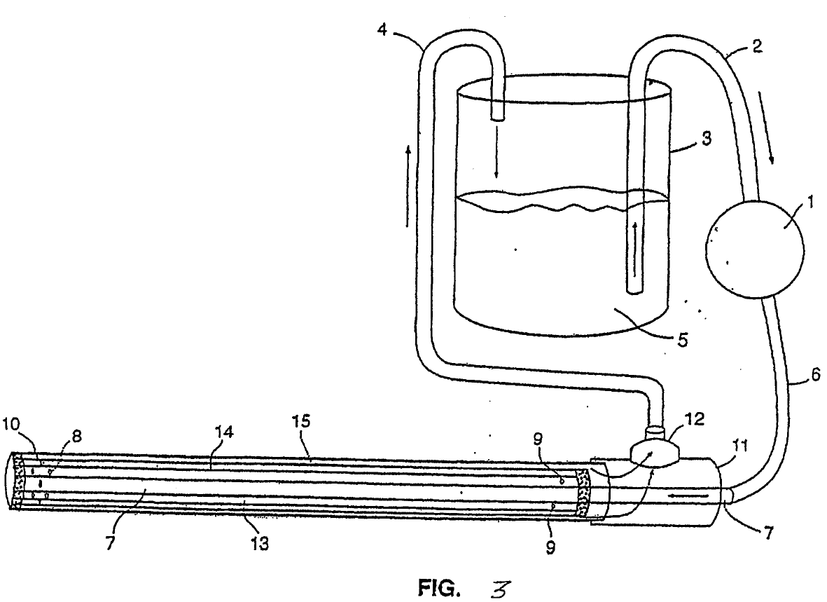

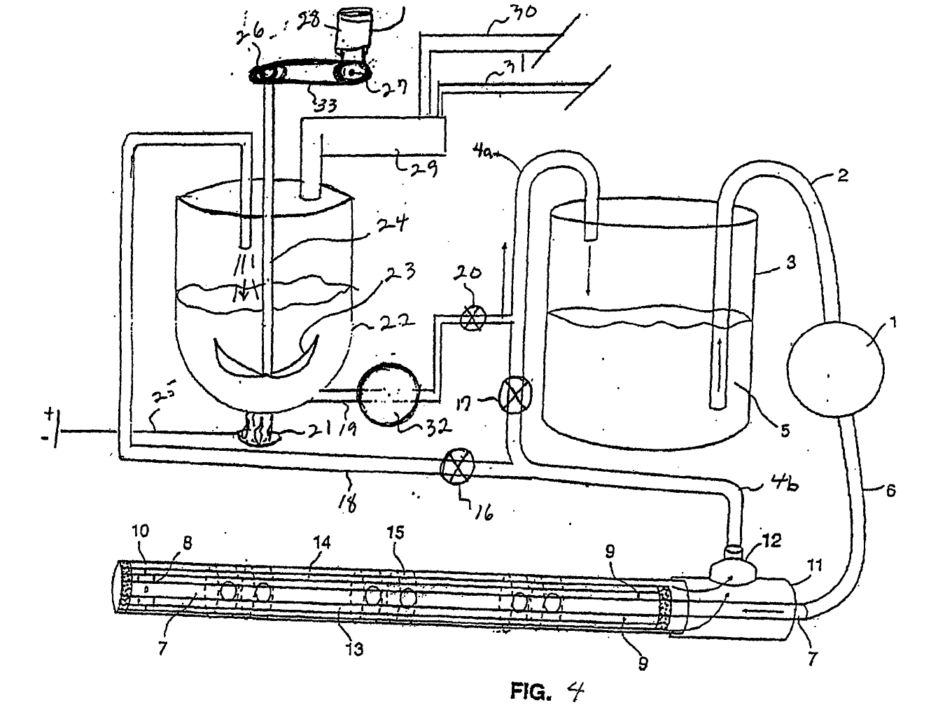

Once the aqueous composition of this invention is prepared, it is preferably further treated to provide a supersaturated solution of the boron salt. Preferably the composition is treated to increase the electrostatic charge on the particles. During the preparation of the composition of this invention, it is important to maintain the temperature above ambient to maintain solubility of the salts. Once the composition is passed through the electret generator to achieve a higher zeta potential, the composition stabilizes. This is done by using a generator displayed in FIGS. 3 and 4. Further details may be found in U.S. patent application Ser. No. 09/749,243 to Holcomb, filed on Dec. 26, 2000 and published as US 2001/0027219 on Oct. 4, 2001, and in U.S. Pat. No. 5,537,363 to Holcomb, issued on Jul. 16, 1996, the disclosures of which are incorporated by reference herein in their entirety. The size and volumes in these publications and herein are for illustration only and are not limiting. The functioning of the generator entails a pump (1) which picks up the composition of the invention (5) which is contained in containment means (3) and flows through conduit (2) and through pump (1). The pump (1) generates a velocity that depends on the size of the pump and conduits. This may be 1-100 gallons per minutes (gpm). In smaller systems a flow of 4 to 10 gpm and a pressure of 20 psi may be seen. Fluid at the aforementioned pressure and velocity flows through conduit (6) and enters conduit means (7). The fluid flows through conduit means (7) and exits through holes (8) into conduit means (13), the fluid then flows in the opposite direction, it then exits through holes (9), and reverses direction again through conduit means (14). The fluid exits conduit means (14) through orifices (10) into conduit means (15), this fluid enters chamber (11) and exits the generator proper through conduit (12) and is carried back to containment means (5) through conduit (4a) and (4b).

FIG. 4 illustrates the function and location of the magnetic booster units of the generator along with the “off line” chemical mixing containment means (22). High velocity prolonged flow through the counter current device of the invention will generate the colloid of the invention because of the counter current charge effect which generates multiple bi-directional magnetic fields which generate on electrostatic charge on the adjacent moving charged colloidal particle moving in the counter current process. If one adds the magnetic booster units of FIG. 4, the electrostatic charge builds on the colloid much faster. When the device of FIG. 4 is in full operation valve (17) of conduit (4a) is closed and valve (16) of conduit (18) is opened as well as valve (20) of conduit (19) is opened. Flow goes through conduit (4b) to conduit (18) into containment means (22) where chemicals may be added from chemical feeder (29) which is charged through conduit (30) and (31). The chemical containment means (22) is heated with electric heater (21) which is powered by cord (25) and is agitated by paddle (23) via shaft (24) which is rotated by pulley (26) pulled by belt (33) on pulley (27) powered by motor (28). The heated fluid with dissolved chemicals is pumped via pump (32) through conduit (19) into conduit (4) and back to containment means (5).

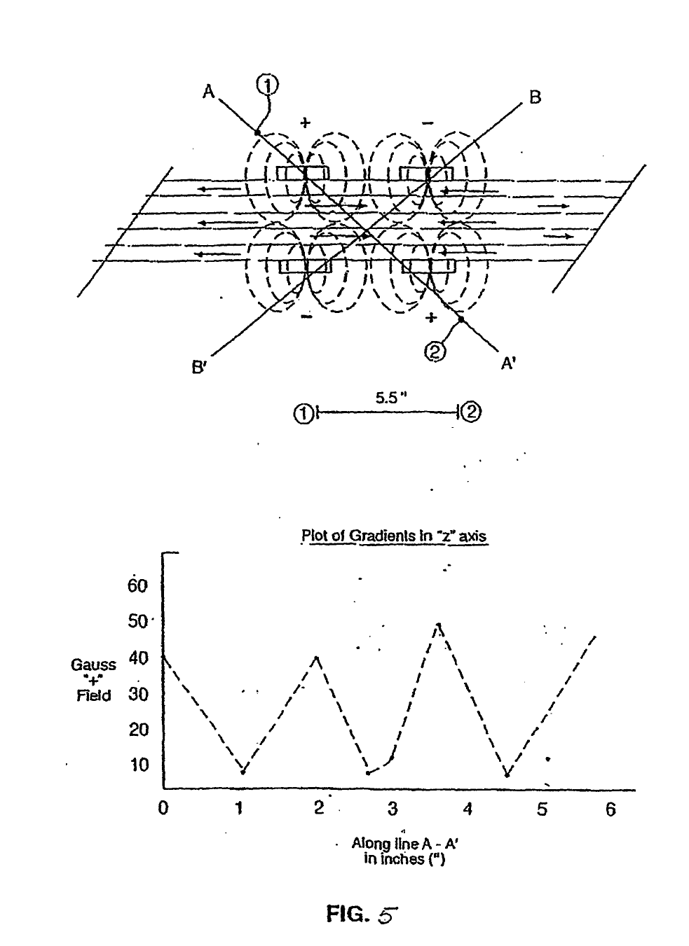

As can be noted from FIG. 5, there are multiple gradients within the pipeline in the z axis, these gradients also exist in the x and y axis. The multiple gradient effect is responsible for the electrostatic charge which builds on the particle as the generator continues to process the material. Upper portion of FIG. 5 illustrates a top cross sectional view of the concentric conduits shown in FIG. 4. As can be noted from FIG. 5, a magnetic booster unit (e.g., unit A) comprises a plurality of magnets (e.g., electromagnets). Here, four magnets are shown arranged in a plane and form vertices of a quadrilateral shape (e.g., a rectangle or square) in that plane. Poles of adjacent magnets are of opposite orientation as indicated by the “+” and “−” signs shown in FIG. 5. As shown in the lower portion of FIG. 5, this arrangement of the four magnets creates multiple gradients for the magnetic field in the z axis (i.e., component of the magnetic field along axis extending out of the plane shown in the upper portion of FIG. 5). Here, measurements are shown for the magnetic field in the z axis along line A-A′ that is displaced about an inch above the plane of the magnets. Gradients can also exist for the magnetic field in the x axis and y axis (i.e., component of magnetic field along lines A-A′ and B-B′). These multiple gradients are responsible for the significant electrostatic charge that can build on the silica colloidal particle as the generator continues to process the aqueous composition. By treating the aqueous composition with the generator shown in FIG. 4, one can produce silica colloidal particles having sizes in the range of about 1 μm to about 200 μm, typically in the range of about 1 μm to about 150 μm or from about 1 μm to about 110 μm. The silica colloidal particles may have zeta potentials in the range of about −5 millivolts (mV) to over about −75 mV, and typically in the range of about −30 mV to about −40 to −75 mV. As one of ordinary skill in the art will understand, a zeta potential represents an electrostatic charge exhibited by a colloidal particle, and a zeta potential of greater magnitude typically corresponds to a more stable colloidal system (e.g., as a result of inter-particle repulsion).

### EXAMPLE 1

This example describes a process for making a representative composition of the invention.

The detailed preparation of the composition may be visualized by referring to FIG. 5. A starting solution is added to container means (5). The solution contains 1,846.2 ml of 26.0% sodium silicate with quantity sufficient of water to bring the volume to 6,500 ml. The solution is circulated through the generator with valve (16) and valve (20) closed but with valve (17) open. 500 Grams of KOH granules are slowly added to the solution in the running generator. The composition is circulated for 30 minutes at 60° C. 2 Liters of solution flow into containment (22) by opening valve (16) and closing valve (17). When 2 liters have flowed into containment means (22) valve (20) is opened and 800 grams of tripotassium citrate is slowly added to the solutions in containment means (22) through chemical feeder (29) and stirred with paddle (23) and rod (24) until dissolved. 1000 Gm of borax (sodium tetraborate decahydrate) is added to solution through chemical feed (29). The borax is dissolved by stirring with paddle (21) on shaft (24). The generator runs for 1 hour. A second 1,000 grams of borax is added and circulated until it is dissolved. The temperature is kept at 60° C. The generator is run for 1 hour and a third 1,000 grams of borax is added, stirred and circulated until it is dissolved. 10 Grams AlF₃ is added and run through the generator for one hour to a final pH of 10.8. The composition is bottled by closing valve (16) and opening valve (17) and pumping the solution out of containment means (22) via pump (32) into containment means (5) via conduit (4).

### EXAMPLE 2

This example describes a process of the invention for the pressure treatment of wood. Referring to FIG. 8, lumber to be treated (56) is placed in pressure chamber (54) and sealed with door (55). Valves (58) and (64) are closed. Valve (68) is opened and vacuum pump (67) is powered through power conduit (19b). In one embodiment of the system, the vacuum pump (67) is a 26 inch vacuum pump. However, the vacuum pump can be a vacuum pump of any size, such as a 30 inch vacuum pump.

The vacuum pump (67) is pumped on the chamber (54) to eliminate the gases that are contained within the wood fibers. The vacuum eliminates the gases from the ends of the wood. Thus, the amount of time that the vacuum is required to be maintained on the chamber (54) depends on the quantity, the type, and the length of wood that is being treated. For example, for a small amount of wood the vacuum may be maintained for 15 minutes and for a large amount of wood, or a long piece of wood, the vacuum may be maintained for 45 minutes. Valve (58) is then opened and a composition of the invention (e.g. 6% SiO₂ and 8% boron-containing salt for the boron ion) is sucked from a containment means (62) and/or a storage means (66) into the chamber (4) and subsequently into the wood. The composition travels from the storage means (66) to the containment means (62) through conduit (65). The composition travels from the containment means (62) to the chamber (54) through conduits (57) and (60). Prior to entering the chamber (54) the composition may be passed through a boiler (59). The boiler (59) is any type of heating element that will allow the temperature of the composition to be maintained as it is circulated through the system.

In an alternative embodiment, prior to allowing the composition to enter the treatment chamber SILENE® (calcium silicate) is mixed with water in at a low concentration (e.g., 1½%) of SILENE and the wood is treated with the SILENE composition and the composition of the invention.

Once the preservative has filled the chamber (54) and the wood is immersed in the preservative, the system undergoes a pressure stage.

In one embodiment of the process liquid pressure is applied to the system. In this embodiment, the vacuum is pulled, valve (68) is closed, valve (58) is opened, and a liquid pressure pump (P) is turned on. When the chamber is fall of liquid from containment means (62), through conduit (60), boiler (59) and conduit (57) (conduit (57) would be moved toward the open end of the chamber) pump (P) would continue to run, valve (64) is partially opened. The partial restriction will maintain a pressure in the tank and still allow circulation. The entire system may be equipped with pH and TDS (total dissolved salts) sensors so that make up solution can be added as necessary. The entire system may be computer controlled.

In one embodiment, the liquid pressure is maintained at about 150 pounds per square inch and the temperature is maintained at about 140° F. for a period of time between 30 minutes and 2 hours. However, in another embodiment other pressures, other temperatures, and other times may be used.

In another embodiment of the system a gas pressure is applied to the system. In this embodiment, the system is circulated under pressure pump (P). The pressure is applied by CO₂ container (51) through conduit (53) and valve (69) to the wood chamber (4). The composition, which is a small particle colloid at high pH, is partially converted to a gel by the CO₂. This is thought to lower pH at the surface of the wood. The pressure is applied to the system for anywhere from about 30 minutes to about 2 hours. The amount of time that the pressure is applied to the system depends on the quantity, the type, and the length of the wood that is being treated.

Once the pressure stage is completed, the chamber is drained. The treated wood is then removed from the chamber (54) and is allowed to dry for a period of about 30 days.

The formula of the composition may be altered for better penetration. Boric acid may be substituted for borax (sodium tetraborate decahydrate) if boric acid is used the amount is 1.22 more by weight than borax.

### EXAMPLE 3

This composition of the invention is designed to paint or spray on decks or lumber.

1. 1200 ml of 4M HCl is added to 5,300 ml of distilled H₂O and placed in the generator.

2. Slowly add 800 mgs tripotassium citrate solution to the reservoir. Circulate for 30 minutes.

3. Dissolve 1000 grams of borax (sodium tetraborate decahydrate) in 1846.2 ml of 26% sodium silicate. Add 500 gms of KOH to dissolve as needed and add 200 gms NaOH. Heat to 200° F. to dissolve.

4. Slowly add a portion of borax/sodium silicate solution to generator over one hour or to pH 7.6 and add 10 grams AlF₃. Continue to add the borax/sodium silicate at 46.3° C. until a pH of 10.76 is reached.

5. Add 1000 ml of above solution to a container with constant stirring at pH 11.33 and T 22.2° C. Titrate with HCl 1:3 (use 150 ml HCl×150 ml) and slowly add 4 liters of above pressure treatment solution to 4 liters of the present solution (Example 2) and stir. This solution is clear and penetrates wood well.

### EXAMPLE 4

In this example the above-described composition (Example 3) of the invention is combined with a wood sealer. In one embodiment, the wood sealer is a 10% active blend of Silene (calcium silicate) blended with anhydrous alcohol. The spray on composition (from Example 3)is applied to the decking and allowed to dry for 3-4 hours. The wood sealer is then applied to the deck. The wood sealer chemically reacts with the decking treatment by reacting with the silica. The resultant is treated lumber with a water repellant sealer.

### EXAMPLE 5

Another embodiment of the invention is perfected by the synthesis of a saturated solution of 21% borax and 21% SiO₂. The solution is very viscous. It is heated and mixed with fiber of any type and dried under hot roller presses to make a very strong and fire proof sheet of building material. All of the products treated with the invention are fire retardant.

### EXAMPLE 6

Southern yellow pine 2″×4″ wood pieces and white oak of similar size was pressure treated according to the invention. The immediate wt gain and wt gain after 1 month is prorated.

| | Immediate | Wt gain at |
|---|---|---|
| | wt gain | one month |
| Pine | 44.8% | 22.5% |
| Oak | 34.4% | 22.25% |

### EXAMPLE 7

In this example of the present invention, a composition that may be used to spray on a wood deck is produced. The composition may be produced using the following procedure.

A. Prepare solution A

1) Add 431.340 liters of 4N HCl to 1905.085 liters of H₂O in an inorganic polymer electret generator (see for example U.S. patent application Ser. No. 09/749,243, filed 26 Dec. 2000) and circulate for 30 minutes.

2) Slowly add 287.560 Kg of tripotassium citrate to the generator reservoir and circulate for 30 minutes.

3) Dissolve 202.185 Kg of borax in 995.425 liters of 27% NaSiO₄. Add 101.095 Kg of KOH to the solution to dissolve the borax. Add 38 Kg of NaOH and heat the solution to 220° F. Once all the borax is dissolved add two additional quantities of 202.185 Kg of borax, one at a time, to dissolve a total of 606.455 Kg borax.

4) Slowly add the borax/sodium silicate solution to the generator over ½ hour.

5) Add 3.594 Kg of AlF₃ slowly to the generator reservoir and circulate for one hour.

B. Prepare solution B

1) Add 673.491 liters of 27% sodium silicate NaSiO₄ by weight to enough H2O to have 2,556.680 liters of solution.

2) Slowly add 394.72 Kg of KOH pellets.

3) Circulate for 30 minutes in the electret generator as above.

4) Draw off 789.44 liters from the generator vessel. Transfer to a heat pot at 200° F. Stir in 222.03 Kg of NaOH pellets—continue to heat and stir until clear.

5) Return to the generator and circulate for 30 minutes.

6) Draw off 1184.2 liters from the generator vessel and transfer to the heat pot at 200° F. Add 18.872 of NaOH pellets and slowly dissolve 333.056 Kg of boric acid, stir. Add 57 Kg of NaOH pellets and stir until clear.

7) Add 315 Kg of tripotassium citrate to 300 liters drawn from the generator vessel—stir until dissolved and return to the generator—circulate for 10 minutes.

8) Circulate #6 above back into the generator and circulate for 10 minutes.

9) Draw off 1200 liters from generator vessel and transfer to a heat pot at 200° F. Add 38.25 Kg NaOH pellets and slowly dissolve 263.25 Kg of boric acid. Add sufficient amounts of additional NaOH to dissolve the boric acid.

10) Add the 1200 liters of #9 above back to the generator and run for 10 minutes.

11) Draw off 600 liters from the generator vessel and dissolve 3.947 Kg AlF₃ and add back to the generator with enough H₂O to produce 3000 liters. Circulate for 30 minutes and place in a container.

C. Prepare the final product

1) Add 1500 liters of solution B to the generator and slowly titrate over 15 minutes 1500 liters of solution A and run for 15 min.

The composition produced using this procedure has silica (probably as sodium silicate) present at a level of about 6% by weight calculated by known weight/volumes and has borax (as boron ions) present at a level of about 4.5% by weight calculated by known weight volumes. The composition produced using this procedure has a pH of about 10.

### EXAMPLE 8

In this example of the present invention, a composition that may be used to spray on a wood deck that has been treated with CCA is produced. The composition may be produced using the following procedure.

A. Prepare solution A

1) Add 431.34 liters of 4N HCl to 1905.085 liters of H₂O in an inorganic polymer electret generator and circulate for 30 minutes.

2) Slowly add 287.560 Kg of tripotassium citrate to the generator reservoir and circulate for 30 minutes.

3) Dissolve 89.860 Kg of borax in 1659.042 liters of 27% NaSiO₄. Add 44.931 of KOH to the solution to dissolve the borax. Add 16.888 Kg of NaOH and heat solution to 200° F. Add two additional separate aliquots of 89.860 Kg of borax to the solution and dissolve each aliquot separately.

4) Slowly add the borax/sodium silicate solution to the generator over ½ hour.

5) Add 3.594 Kg of AlF₃ slowly to the generator reservoir and circulate for one hour.

B. Prepare solution B

1) Add 1122.484 liters of 27% NaSiO₄ sodium silicate by weight with enough H₂O to produce 2,556.680 liters of solution.

2) Slowly add 175.431 Kg of KOH pellets.

3) Circulate for 30 minutes in the electret generator as above.

4) Draw off 789.44 liters from the generator vessel. Transfer to a heat pot at 200° F. Stir in 98.679 Kg of boric acid along with 33.353 Kg of NaOH pellets—continue to heat and stir until clear.

5) Return to the generator and circulate for 30 minutes.

6) Draw off 1184.2 liters from the generator vessel and transfer to a heat pot at 200° F. Add 8.379 Kg of NaOH pellets and slowly dissolve 147.877 Kg of boric acid, stir and add 25.308 Kg of NaOH pellets. Stir until clear.

7) Add 315 Kg of tripotassium citrate to 300 liters drawn from the generator vessel—stir until dissolved and return to the generator—circulate for 10 minutes.

8) Circulate #6 above back into the generator and circulate for 10 minutes.

9) Draw off 1200 liters from generator vessel and transfer to heat pot at 200° F. Add 16.983 Kg NaOH pellets and slowly dissolve 196.83 Kg of boric acid. Add sufficient amounts of additional NaOH to dissolve the boric acid.

10) Add the 1200 liters of #9 above back to the generator and run for 10 minutes.

11) Draw off 600 liters from generator vessel and dissolve 3.947 Kg AlF₃ and add back to the generator with enough H₂O to produce 3000 liters. Circulate for 30 minutes.

C. Prepare the final product

1) Add 1500 liters of solution B to generator and slowly titrate over 15 minutes 1500 liters of solution A and run for 15 min.

The composition produced using this procedure has silica present at a level of about 10% by weight calculated by known weight/volumes and has borate ion present at a level of about 2% by weight calculated at known weight volumes. The composition produced using this procedure has a pH of about 10.4 to about 10.6.

### EXAMPLE 9

In this example of the present invention, a composition that may be used to pressure treat wood is produced. This composition provides a termite resistance to the wood. The composition may be produced using the following procedure.

1) Add 897.988 liters of 27% NaSiO₄ by weight with enough H₂O to produce 2,556.68 liters of solution.

2) Slowly add 197.360 Kg of KOH pellets with stirring.

3) Circulate for 30 minutes in an electret generator as above.

4) Draw off 592.1 liters from the generator vessel and transfer to a heat pot at 200° F. Stir in 197.360 Kg boric acid along with 66.708 Kg of NaOH pellets. Continue to heat and stir until clear.

5) Return to the generator and circulate for 30 minutes.

6) Draw off 592.1 liters from the generator vessel and transfer to heat at 200° F. Add 16.776 Kg of NaOH pellets and slowly dissolve 296.05 Kg of boric acid. Stir and add 50.00 Kg of NaOH pellets or until clear.

7) Add 315 Kg tripotassium citrate to 300 liters drawn from the generator vessel—stir until dissolved and return to the generator—circulate for 10 minutes.

8) Circulate #6 above back into the generator and circulate for 10 minutes.

9) Draw off 600 liters from the generator vessel and transfer to a heat pot at 200° F. Add 34 Kg of NaOH pellets and slowly dissolve 234 Kg of boric acid. Add a sufficient amount of additional NaOH to dissolve the boric acid.

10) Add 600 liters of #9 above back to the generator and run for 10 minutes.

11) Draw off 600 liters from generator vessel and dissolve 3.947 Kg AlF₃ and add back to the generator with, if needed, enough H2O to produce 3,000 liters of solution. Circulate for 30 minutes.

The composition produced using this procedure has silica present at a level of about 8% by weight calculated by known weight/volumes and a level of borate ion of about 4% by weight calculated by known weight/volumes. The composition produced using this procedure has a pH of about 10.5 to about 11.5.

### EXAMPLE 10

In this example of the present invention, a composition that may be used to pressure treat utility ties such as railroad ties and structural timbers and fence posts used in marine environments is produced. The composition may be produced using the following procedure.

1) Add 1,122.485 liters of 27% NaSiO₄ by weight with enough H₂O to produce 2,556.68 liters of solution.

2) Slowly add 394.72 Kg of KOH pellets with stirring.

3) Circulate for 30 minutes in an electret generator as above.

4) Draw off 986.6 liters from the generator vessel. Transfer to heat pot at 200° F. Stir in 493.4 Kg boric acid along with 166.77 Kg of NaOH pellets. Continue to heat and stir until clear.

5) Return to the generator and circulate for 30 minutes.

6) Draw off 1,480.25 liters from the generator vessel and transfer to a heat pot at 200° F. Add 41.9375 Kg of NaOH pellets and slowly dissolve 740.125 Kg of boric acid. Stir and add 125.00 Kg of NaOH pellets or until clear.

7) Add 315 Kg tripotassium citrate to 300 liters drawn from the generator vessel—stir until dissolved and return to the generator—circulate for 10 minutes.

8) Circulate #6 above back into generator and circulate for 10 minutes.

9) Draw off 1500 liters from the generator vessel and transfer to heat pot at 200° F. Add 85 Kg of NaOH pellets and slowly dissolve 585.0 Kg of boric acid. Add a sufficient amount of additional NaOH to dissolve the boric acid.

10) Add 1500 liters of #9 above back to the generator and run for 10 minutes.

11) Draw off 1000 liters from generator vessel and dissolve 3.947 Kg AlF₃ and add back to the generator with, if needed, enough H₂O to produce to 3,000 liters of solution and circulate for 30 minutes.

The composition produced using this procedure has silica present at a level of about 10% by weight calculated by known weight/volumes and borate ions present at a level of about 10% by weight calculated at known weight/volumes. The composition produced by this process has a pH of about 10.5 or higher.

### EXAMPLE 11

In this example of the present invention, a composition that may be used to pressure treat wood is produced. This composition provides a high termite barrier to the wood. The composition may be produced using the following procedure.

1) Add 897.988 liters of 27% NaSiO₄ by weight with enough H₂O to produce 2,556.68 liters of solution.

2) Slowly add 394.72 Kg of KOH pellets with stirring.

3) Circulate for 30 minutes in an electret generator as above.

4) Draw off 789.44 liters from the generator vessel. Transfer to heat pot at 200° F. Stir in 394.72 Kg boric acid along with 133.416 Kg of NaOH pellets—continue to heat and stir until clear.

5) Return to the generator and circulate for 30 minutes.

6) Draw off 1184.2 liters from generator vessel and transfer to heat at 200° F. Add 33.55 Kg of NaOH pellets and slowly dissolve 592.10 Kg of boric acid, stir and add 100.00 Kg of NaOH pellets or until clear.

7) Add 315 Kg tripotassium citrate to 300 liters drawn from the generator vessel—stir until dissolved and return to the generator—circulate for 10 minutes.

8) Circulate #6 above back into the generator and circulate for 10 minutes.

9) Draw off 1200 liters from the generator vessel and transfer to heat pot at 200° F. Add 68 Kg of NaOH pellets and slowly dissolve 468.00 Kg of boric acid. Add a sufficient amount of additional NaOH to dissolve the boric acid.

10) Add the 1200 liters of #9 above back to the generator and run for 10 minutes.

11) Draw off 600 liters from the generator vessel and dissolve 3.947 Kg AlF₃ and add back to generator with enough water to produce 3,000 liters of solution. Circulate for 30 minutes.

The composition produced using this procedure has silica present at a level of about 8% by weight calculated by known weight/volumes and a level of borate ions of about 8% by weight calculated by known weight/volumes. The composition produced using this procedure has a pH of about 10.5 or higher.

### EXAMPLE 12

In this example of the present invention, a composition that may be sprayed on wood to help protect the wood against termites is produced. The composition may be produced using the following procedure.

A. Prepare solution A

1) Add 431.340 liters of 4N HCl to 1905.085 liters of H₂O in an inorganic polymer electret generator and circulate for 30 minutes.

2) Slowly add 287.560 Kg of tripotassium citrate to the generator reservoir and circulate for 30 minutes.

3) Dissolve 359.44 Kg of borax in 663.617 liters of 27% NaSiO₄ three times. Add 179.725 Kg of KOH to solution to dissolve the borax. Add 71.890 Kg of NaOH and heat solution to 200° F.

4) Slowly add the borax/sodium silicate solution to generator over ½ hour.

5) Add 3.594 Kg of AlF₃ slowly to the generator reservoir and circulate for one hour.

B. Prepare solution B

1) Add 448.994 liters of 27% NaSiO₄ by weight with enough H₂O to produce 2,556.68 liters of solution.

2) Slowly add 394.72 Kg of KOH pellets.

3) Circulate for 30 minutes in an electret generator as above.

4) Draw off 789.44 liters from the generator vessel. Transfer to a heat pot at 200° F. Stir in 394.72 Kg of boric acid along with 133.416 Kg of NaOH pellets—continue to heat and stir until clear.

5) Return to the generator and circulate for 30 minutes.

6) Draw off 1184.2 liters from the generator vessel and transfer to heat pot at 200° F. Add 33.55 Kg of NaOH pellets and slowly dissolve 592.10 Kg of boric acid, stir and add 100.00 Kg of NaOH pellets or until clear.

7) Add 315 Kg tripotassium citrate to 300 liters drawn from the generator vessel—stir until dissolved and return to the generator—circulate for 10 minutes.

8) Circulate #6 above back into the generator and circulate for 10 minutes.

9) Draw off 1200 liters from generator vessel and transfer to heat pot at 200° F. Add 68 Kg of NaOH pellets and slowly dissolve 468.00 Kg of boric acid. Add a sufficient amount of additional NaoH to dissolve the boric acid.

10) Add the 1200 liters of #9 above back to generator and run for 10 minutes.

11) Draw off 600 liters from the generator vessel and dissolve 3.947 Kg AlF₃ and add back to the generator with enough H₂O to produce 3,000 liters of solution. Circulate for 30 minutes.

C. Prepare the final product

1) Add 1500 liters of solution B to the generator and slowly titrate over 15 minutes 1500 liters of solution A and run for 15 minutes.

The composition produced using this procedure has silica present at a level of about 4% by weight calculated by known weight/volumes and a level of borate ions of about 8% by weight calculated by known weight/volumes. The composition produced using this procedure has a pH of about 10.2 or higher.

The subject matter claimed is:

1. A process for reducing the rate of deterioration of wood, which process comprises contacting wood with an aqueous mixture comprising an alkaline, colloidal composition of a silicon-containing salt having boron ions incorporated therein for time sufficient to impregnate at least a portion of the wood with the mixture.

2. The process of claim 1, wherein the wood is contacted by immersing the wood in the aqueous mixture at a pressure above atmospheric pressure in a closed container.

3. The process of claim 2, wherein the pressure is generated by increasing the rate of flow of the aqueous mixture into the container while decreasing the rate of flow out of the container.

4. The process of claim 2, wherein the pressure is about 125 psi to about 175 psi and is produced using liquid pressure.

5. The process of claim 4, wherein the pressure is maintained for about 30 minutes to about 2 hours.

6. The process of claim 5, wherein the dry weight of the wood is increased by a factor of about 20% to about 70% more than the wood's original weight.

7. The process of claim 1, wherein after the wood has been impregnated with the composition, the wood is removed from contact with the aqueous composition and dried to provide a product having a silicon-containing salt and a boron-containing salt deposited therein.

8. The process of claim 1, wherein the alkaline, silicon-containing salt composition comprises water made basic to a pH of at least about 10 with an alkali metal hydroxide, silica, a metal borate or boric acid, and optionally an aluminum halide.

9. The process of claim 7, wherein the alkaline, silicon-containing salt composition comprises water containing sodium hydroxide or potassium hydroxide to make the pH of about 10 to 11, about 2%-20% w/v silica, about 2%-20% w/v of a boron-containing salt and optionally an aluminum halide.

10. The process of claim 8, wherein the alkaline, silicon-containing salt composition comprises water containing about 3 to about 4 molar concentration of sodium hydroxide or potassium hydroxide, about 2% to about 20% w/v silica in the form of a silicate, about 2% to about 20% w/v borax, about 0.1% to about 1% w/v aluminum halide, and a stabilizing amount of tripotassium citrate.

11. The process of claim 9, wherein the water contains potassium hydroxide.

12. The process of claim 1, wherein the wood is contacted by applying the aqueous composition to the surface of the wood at ambient pressure and allowing it to dry.

13. The process of claim 12, wherein the aqueous composition is applied with a brush.

14. The process of claim 12, wherein the aqueous composition is applied by spraying.

15. The process of claim 2, wherein the wood is dried for at least 30 days under ambient conditions after the pressure treatment.

16. The process of claim 2, wherein the wood is treated with an aqueous solution of calcium silicate along with the alkaline, silicon-containing salt composition.

17. An article of manufacture that comprises wood impregnated with a silicon-containing salt, a boron-containing salt, and optionally an aluminum halide.

18. The article of manufacture of claim 17, wherein the silicon-containing salt is present at a level in the wood of about 1% w/w to about 30% w/w and the boron-containing salt is present at a level in the wood of about 1% w/w to about 30% w/w.

19. The article of claim 17, wherein the dry weight of the impregnated wood is greater by a factor of about 20% to about 70% more than comparable unimpregnated wood.

20. The article of claim 19, wherein the impregnated wood is impregnated substantially throughout the structure of the wood.

21. The article of claim 17, wherein the wood is impregnated at the surface of the wood.

22. The article of claim 21, wherein the impregnation occurs by spraying or brushing an alkaline, colloidal silica composition supersaturated with a boron-containing salt, and optionally an aluminum halide.

23. A colloidal composition that comprises:
water,
an alkali metal hydroxide in a quantity sufficient to bring the pH of the water to at least 10,
a silicon-containing salt,
a boron-containing salt,
optionally aluminum halide, and
optionally a preservative.

24. The composition of claim 23, wherein the alkali metal hydroxide is sodium hydroxide or potassium hydroxide.

25. The composition of claim 23, wherein the alkali metal hydroxide is potassium hydroxide.

26. The composition of claim 23, wherein the composition is a colloidal suspension in which the colloidal particles exhibit a zeta potential of about −40 to about −75 mV.

27. The composition of claim 23, wherein the silicon-containing salt is present at a level of about 2% w/v to about 20% w/v.

28. The composition of claim 27, wherein the silicon-containing salt is present at a level of at least about 4% w/v.

29. The composition of claim 27, wherein the boron-containing salt is present at a level of about 2% w/v to 20% w/v.

30. The composition of claim 23, wherein the preservative is tripotassium citrate.

31. The composition of claim 23, wherein the aluminum halide is aluminum trichloride or aluminum trifluoride present in up to about 1.0% w/v.

32. The composition of any of claims 23-31, wherein the colloidal particles exhibit a zeta potential of about −40 to about −75 mV.

33. A process for making a composition suitable for reducing the rate of deterioration of wood, which process comprises
(a) mixing a boron-containing salt with an alkali-metal silicate colloidal mixture at a pH of at least 10,
(b) optionally adding an aluminum halide and a preservative, and
(c) mixing to form a uniform colloidal composition being supersaturated with the boron-containing salt.

34. The process of claim 33, wherein the alkaline metal silicate solution is adjusted to a pH of 10 using potassium hydroxide or sodium hydroxide.

35. The process of claim 34, wherein the water is adjusted to a pH of at least 10 with potassium hydroxide.

36. The process of claim 34, wherein the boron-containing salt is borax.

37. The process of claim 33, wherein the silicon-containing salt is present at a level of about 2% w/v to about 20% w/v.

38. The process of claim 37, wherein the silicon-containing salt is present at a level of at least about 4% w/v.

39. The process of claim 33, wherein the boron-containing salt is present at a level of about 2% w/v to 20% w/v.

40. The process of claim 33, wherein the preservative is tripotassium citrate.

41. The process of claim 33, wherein the aluminum halide is aluminum trichloride present in up to about 1.0% w/v.

42. The process of any of claims 33-41, wherein the process is carried out under conditions that result in colloidal particles of the composition that exhibit a zeta potential of about −40 to about −75 mV.

43. The process of any of claims 33-42, wherein the colloidal composition is flowed in a countercurrent manner through a magnetic field for a time sufficient to provide colloidal particles with a zeta potential of about −40 to about −75 mV.

44. The process of claim 2, wherein the immersion and pressure is maintained for a period long enough to impregnate the wood substantially throughout its structure.
